(19) United States
(12) Patent Application Publication
(10) Pub. No.: US 2020/0077703 A1
(43) Pub. Date: Mar. 12, 2020

(54) WICKING ELEMENT FOR AEROSOL DELIVERY DEVICE

(71) Applicant: RAI Strategic Holdings, Inc., Winston-Salem, NC (US)

(72) Inventors: Luis R. Monsalud, JR., Kernersville, NC (US); Vahid Hejazi, Winston-Salem, NC (US); Steven Lee Alderman, Lewisville, NC (US)

(73) Assignee: RAI Strategic Holdings, Inc., Winston-Salem, NC (US)

(21) Appl. No.: 16/127,625

(22) Filed: Sep. 11, 2018

(51) Int. Cl. A24F 47/00; A24B 15/16; C03C 11/00; C04B 38/00; H05B 3/46

(52) U.S. Cl. CPC A24F 47/008; A24B 15/167; C03C 11/005; H05B 2203/021; C04B 38/0067; H05B 3/46; C04B 38/0051

(57) ABSTRACT

An aerosol delivery device includes an outer housing, a reservoir containing a liquid, a heater configured to vaporize the liquid, and a liquid transport element configured to provide the liquid to the heater. The liquid transport element includes a rigid monolith. At least a portion of the rigid monolith is substantially cylindrical. The cylindrical portion has an exterior surface and a longitudinal axis. The exterior surface has at least one discontinuity.

### FIELD OF THE DISCLOSURE

The present disclosure relates to aerosol delivery devices and components therefore, and more particularly to aerosol delivery devices that may utilize electrically generated heat for the production of aerosol (e.g., commonly referred to as electronic cigarettes). The aerosol delivery devices may be configured to heat an aerosol precursor, which may incorporate materials that may be made or derived from tobacco or otherwise incorporate tobacco, the precursor being capable of forming an inhalable substance for human consumption.

### BACKGROUND

Many devices have been proposed through the years as improvements upon, or alternatives to, smoking products that require combusting tobacco for use. Many of those devices purportedly have been designed to provide the sensations associated with cigarette, cigar, or pipe smoking, but without delivering considerable quantities of incomplete combustion and pyrolysis products that result from the burning of tobacco. To this end, there have been proposed numerous smoking products, flavor generators, and medicinal inhalers that utilize electrical energy to vaporize or heat a volatile material, or attempt to provide the sensations of cigarette, cigar, or pipe smoking without burning tobacco to a significant degree. See, for example, the various alternative smoking articles, aerosol delivery devices, and heat generating sources set forth in the background art described in U.S. Pat. No. 7,726,320 to Robinson et al., U.S. Pat. Pub. No. 2013/0255702 to Griffith Jr. et al., and U.S. Pat. Pub. No. 2014/0096781 to Sears et al., which are incorporated herein by reference. See also, for example, the various types of smoking articles, aerosol delivery devices, and electrically powered heat generating sources referenced by brand name and commercial source in U.S. Pat. Pub. No. 2015/0216232 to Bless et al., which is incorporated herein by reference in its entirety.

Representative products that resemble many of the attributes of traditional types of cigarettes, cigars or pipes have been marketed as ACCORD® by Philip Morris Incorporated; ALPHA™, JOYE 510™ and M4™ by InnoVapor LLC; CIRRUS™ and FLING™ by White Cloud Cigarettes; BLU™ by Fontem Ventures B.V.; COHITA™, COLIBRI™, ELITE CLASSIC™, MAGNUM™, PHANTOM™ and SENSE™ by EPUFFER® International Inc.; DUOPRO™, STORM™ and VAPORKING® by Electronic Cigarettes, Inc.; EGAR™ by Egar Australia; eGo-C™ and eGo-T™ by Joyetech; ELUSION™ by Elusion UK Ltd; EONSMOKE® by Eonsmoke LLC; FIN™ by FIN Branding Group, LLC; SMOKE® by Green Smoke Inc. USA; GREENARETTE™ by Greenarette LLC; HALLIGAN™, HENDU™, JET™, MAXXQ™ PINK™ and PITBULL™ by SMOKE STIK®; HEATBAR™ by Philip Morris International, Inc.; HYDRO IMPERIAL™ and LXE™ from Crown7; LOGIC™ and THE CUBAN™ by LOGIC Technology; LUCI® by Luciano Smokes Inc.; METRO® by Nicotek, LLC; NJOY® and ONEJOY™ by Sottera, Inc.; NO. 7™ by SS Choice LLC; PREMIUM ELECTRONIC CIGARETTE™ by PremiumEstore LLC; RAPP E-MYSTICK™ by Ruyan America, Inc.; RED DRAGON™ by Red Dragon Products, LLC; RUYAN® by Ruyan Group (Holdings) Ltd.; SF® by Smoker Friendly International, LLC; GREEN SMART SMOKER® by The Smart Smoking Electronic Cigarette Company Ltd.; SMOKE ASSIST® by Coastline Products LLC; SMOKING EVERYWHERE® by Smoking Everywhere, Inc.; V2CIGS™ by VMR Products LLC; VAPOR NINE™ by VaporNine LLC; VAPOR4LIFE® by Vapor 4 Life, Inc.; VEPPO™ by E-CigaretteDirect, LLC; VUSE® by R. J. Reynolds Vapor Company; Mistic Menthol product by Mistic Ecigs; and the Vype product by CN Creative Ltd; IQOS™ by Philip Morris International; and GLO™ by British American Tobacco. Yet other electrically powered aerosol delivery devices, and in particular those devices that have been characterized as so-called electronic cigarettes, have been marketed under the tradenames COOLER VISIONS™; DIRECT E-CIG™; DRAGONFLY™; EMIST™; EVERSMOKE™; GAMUCCI®; HYBRID FLAME™; KNIGHT STICKS™; ROYAL BLUES™; SMOKETIP®; and SOUTH BEACH SMOKE™.

It would be desirable to provide a liquid transport element for an aerosol precursor composition for use in an aerosol delivery device, the liquid transport element being provided so as to improve formation of the aerosol delivery device. It would also be desirable to provide aerosol delivery devices that are prepared to utilize such liquid transport elements.

### SUMMARY OF THE DISCLOSURE

The present disclosure relates to aerosol delivery devices and elements of such devices. The aerosol delivery devices can particularly integrate improved wicking elements to form vapor-forming units that can be combined with power units to form the aerosol delivery devices.

In one or more embodiments, the present disclosure can provide a liquid transport element that includes a rigid monolith. The rigid monolith comprises an exterior surface and a longitudinal axis. The exterior surface comprises at least one discontinuity.

In one or more embodiments, the present disclosure can provide an atomizer comprising a fluid transport element that includes a rigid monolith. The rigid monolith comprises an exterior surface and a longitudinal axis. The exterior surface comprises at least one discontinuity. The atomizer also has a heater comprising a conductive heating element engaged with the discontinuity. The conductive heating element is configured to generate heat through resistive heating or inductive heating.

In one or more embodiments, the present disclosure can provide an aerosol delivery device comprising an outer housing, a reservoir containing a liquid, a heater configured to vaporize the liquid, and a liquid transport element configured to provide the liquid to the heater. The liquid transport element comprises a rigid monolith. At least a portion of the rigid monolith is substantially cylindrical. The cylindrical portion comprises an exterior surface and a longitudinal axis. The exterior surface comprises at least one discontinuity.

These and other features, aspects, and advantages of the present disclosure will be apparent from a reading of the following detailed description together with the accompanying drawings, which are briefly described below. The present disclosure includes any combination of two, three, four, or more features or elements set forth in this disclosure or recited in any one or more of the claims, regardless of whether such features or elements are expressly combined or otherwise recited in a specific embodiment description or claim herein. This disclosure is intended to be read holistically such that any separable features or elements of the disclosure, in any of its aspects and embodiments, should be viewed as intended, namely to be combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE FIGURES

Having thus described aspects of the disclosure in the foregoing general terms, reference will now be made to the accompanying drawings, which are not necessarily drawn to scale, and wherein:

FIG. 1 is a partially cut-away view of an aerosol delivery device comprising a cartridge and a power unit including a variety of elements that may be utilized in an aerosol delivery device according to various embodiments of the present disclosure;

FIG. 2 is an illustration of a vapor-forming unit that is substantially tubular or cylindrical in shape for use in an aerosol delivery device according to various embodiments of the present disclosure;

FIG. 3 is a partially cut-away view of a vapor-forming unit showing the internal construction thereof according to various embodiments of the present disclosure;

FIG. 4 is a perspective view of a liquid transport element according to a first embodiment of the present disclosure;

FIG. 5 is a perspective view of a liquid transport element according to a second embodiment of the present disclosure;

FIG. 6 is a perspective view of a liquid transport element according to a third embodiment of the present disclosure; and

FIG. 7 is a perspective view of a liquid transport element according to a fourth embodiment of the present disclosure.

FIG. 8 is a perspective view of a liquid transport element according to a fifth embodiment of the present disclosure.

### DETAILED DESCRIPTION

The present disclosure will now be described more fully hereinafter with reference to example embodiments thereof. These example embodiments are described so that this disclosure will be thorough and complete, and will fully convey the scope of the disclosure to those skilled in the art. Indeed, the disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

As described hereinafter, embodiments of the present disclosure relate to aerosol delivery systems. Aerosol delivery systems according to the present disclosure use electrical energy to heat a material (preferably without combusting the material to any significant degree and/or without significant chemical alteration of the material) to form an inhalable substance; and components of such systems have the form of articles that most preferably are sufficiently compact to be considered hand-held devices. That is, use of components of preferred aerosol delivery systems does not result in the production of smoke—i.e., from by-products of combustion or pyrolysis of tobacco, but rather, use of those preferred systems results in the production of vapors resulting from volatilization or vaporization of certain components incorporated therein. In preferred embodiments, components of aerosol delivery systems may be characterized as electronic cigarettes, and those electronic cigarettes most preferably incorporate tobacco and/or components derived from tobacco, and hence deliver tobacco derived components in aerosol form.

Aerosol generating components of certain preferred aerosol delivery devices may provide many of the sensations (e.g., inhalation and exhalation rituals, types of tastes or flavors, organoleptic effects, physical feel, use rituals, visual cues such as those provided by visible aerosol, and the like) of smoking a cigarette, cigar or pipe that is employed by lighting and burning tobacco (and hence inhaling tobacco smoke), without any substantial degree of combustion of any component thereof. For example, the user of an aerosol delivery device in accordance with some example implementations of the present disclosure can hold and use that component much like a smoker employs a traditional type of smoking article, draw on one end of that piece for inhalation of aerosol produced by that piece, take or draw puffs at selected intervals of time, and the like.

Aerosol delivery devices of the present disclosure also can be characterized as being vapor-producing articles or medicament delivery articles. Thus, such articles or devices can be adapted so as to provide one or more substances (e.g., flavors and/or pharmaceutical active ingredients) in an inhalable form or state. For example, inhalable substances can be substantially in the form of a vapor (i.e., a substance that is in the gas phase at a temperature lower than its critical point). Alternatively, inhalable substances can be in the form of an aerosol (i.e., a suspension of fine solid particles or liquid droplets in a gas). For purposes of simplicity, the term “aerosol” as used herein is meant to include vapors, gases, and aerosols of a form or type suitable for human inhalation, whether or not visible, and whether or not of a form that might be considered to be smoke-like.

Aerosol delivery devices of the present disclosure generally include a number of components provided within an outer body or shell, which may be referred to as a housing. The overall design of the outer body or shell can vary, and the format or configuration of the outer body that can define the overall size and shape of the aerosol delivery device can vary. Typically, an elongated body resembling the shape of a cigarette or cigar can be a formed from a single, unitary housing, or the elongated housing can be formed of two or more separable bodies. For example, an aerosol delivery device can comprise an elongated shell or body that can be substantially tubular in shape and, as such, resemble the shape of a conventional cigarette or cigar. In one embodiment, all of the components of the aerosol delivery device are contained within one housing. Alternatively, an aerosol delivery device can comprise two or more housings that are joined and are separable. For example, an aerosol delivery device can possess at one end a control body (or power unit) comprising a housing containing one or more components (e.g., a battery and various electronics for controlling the operation of that article), and at the other end and removably attached thereto an outer body or shell containing aerosol forming components (e.g., one or more aerosol precursor components, such as flavors and aerosol formers, one or more heaters, and/or one or more wicks).

Aerosol delivery devices of the present disclosure can be formed of an outer housing or shell that is not substantially tubular in shape but may be formed to substantially greater dimensions. The housing or shell can be configured to include a mouthpiece and/or may be configured to receive a separate shell (e.g., a cartridge or tank) that can include consumable elements, such as a liquid aerosol former, and can include a vaporizer or atomizer.

As will be discussed in more detail below, aerosol delivery devices of the present disclosure comprise some combination of a power source (i.e., an electrical power source), at least one control component (e.g., means for actuating, controlling, regulating and ceasing power for heat generation, such as by controlling electrical current flow from the power source to other components of the article—e.g., a microprocessor, individually or as part of a microcontroller), a heater or heat generation member (e.g., an electrical resistance heating element or other component and/or an inductive coil or other associated components and/or one or more radiant heating elements), and an aerosol source member that includes a substrate portion capable of yielding an aerosol upon application of sufficient heat. In various implementations, the aerosol source member may include a mouth end or tip configured to allow drawing upon the aerosol delivery device for aerosol inhalation (e.g., a defined airflow path through the article such that aerosol generated can be withdrawn therefrom upon draw). More specific formats, configurations and arrangements of components within the aerosol delivery systems of the present disclosure will be evident in light of the further disclosure provided hereinafter. Additionally, the selection and arrangement of various aerosol delivery system components can be appreciated upon consideration of the commercially available electronic aerosol delivery devices, such as those representative products referenced in the background art section of the present disclosure.

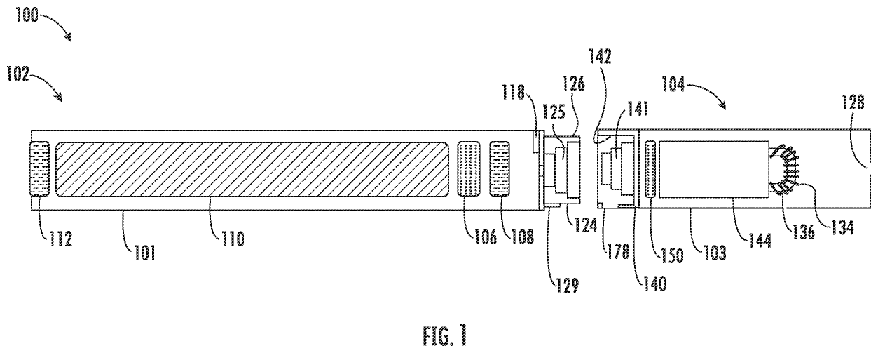

One example embodiment of an aerosol delivery device 100 illustrating components that may be utilized in an aerosol delivery device according to the present disclosure is provided in FIG. 1. As seen in the cut-away view illustrated therein, the aerosol delivery device 100 can comprise a power unit 102 and a cartridge 104 that can be permanently or detachably aligned in a functioning relationship. Engagement of the power unit 102 and the cartridge 104 can be press fit (as illustrated), threaded, interference fit, magnetic, or the like. In particular, connection components, such as further described herein may be used. For example, the power unit may include a coupler that is adapted to engage a connector on the cartridge.

In specific embodiments, one or both of the power unit 102 and the cartridge 104 may be referred to as being disposable or as being reusable.

For example, the control body 102 may have a replaceable battery or a rechargeable battery, solid-state battery, thin-film solid-state battery, rechargeable supercapacitor or the like, and thus may be combined with any type of recharging technology, including connection to a wall charger, connection to a car charger (i.e., cigarette lighter receptacle), and connection to a computer, such as through a universal serial bus (USB) cable or connector (e.g., USB 2.0, 3.0, 3.1, USB Type-C), connection to a photovoltaic cell (sometimes referred to as a solar cell) or solar panel of solar cells, a wireless charger, such as a charger that uses inductive wireless charging (including for example, wireless charging according to the Qi wireless charging standard from the Wireless Power Consortium (WPC)), or a wireless radio frequency (RF) based charger. An example of an inductive wireless charging system is described in U.S. Pat. App. Pub. No. 2017/0112196 to Sur et al., which is incorporated herein by reference in its entirety. Further, in some implementations, the aerosol source member 104 may comprise a single-use device. A single use component for use with a control body is disclosed in U.S. Pat. No. 8,910,639 to Chang et al., which is incorporated herein by reference in its entirety.

As illustrated in FIG. 1, a power unit 102 can be formed of a power unit shell 101 that can include a control component 106 (e.g., a printed circuit board (PCB), an integrated circuit, a memory component, a microcontroller, or the like), a flow sensor 108, a battery 110, and an LED 112, and such components can be variably aligned. Further indicators (e.g., a haptic feedback component, an audio feedback component, or the like) can be included in addition to or as an alternative to the LED. Additional representative types of components that yield visual cues or indicators, such as light emitting diode (LED) components, and the configurations and uses thereof, are described in U.S. Pat. No. 5,154,192 to Sprinkel et al.; U.S. Pat. No. 8,499,766 to Newton; U.S. Pat. No. 8,539,959 to Scatterday; and U.S. Pat. No. 9,451,791 to Sears et al.; and U.S. Pat. Pub. No. 2015/0020825 to Galloway et al.; which are incorporated herein by reference. It is understood that not all of the illustrated elements are required. For example, an LED may be absent or may be replaced with a different indicator, such as a vibrating indicator. Likewise, a flow sensor may be replaced with a manual actuator, such as a push button.

A cartridge 104 can be formed of a cartridge shell 103 enclosing the reservoir 144 that is in fluid communication with a liquid transport element 136 adapted to wick or otherwise transport an aerosol precursor composition stored in the reservoir housing to a heater 134. A liquid transport element can be formed of one or more materials configured for transport of a liquid, such as by capillary action. Generally, a liquid transport element can be formed of, for example, fibrous materials (e.g., organic cotton, cellulose acetate, regenerated cellulose fabrics, glass fibers), porous ceramics, porous carbon, graphite, porous glass, sintered glass beads, sintered ceramic beads, capillary tubes, or the like. Generally, the liquid transport element could be any material that contains an open pore network (i.e., a plurality of pores that are interconnected so that fluid may flow from one pore to another in a plurality of direction through the element). As further discussed herein, some embodiments of the present disclosure can particularly relate to the use of non-fibrous transport elements. As such, fibrous transport elements can be expressly excluded. Alternatively, combinations of fibrous transport elements and non-fibrous transport elements may be utilized.

Various embodiments of materials configured to produce heat when electrical current is applied therethrough may be employed to form the heater 134. Example materials from which the wire coil may be formed include Kanthal (FeCrAl), nichrome, nickel, stainless steel, indium tin oxide, tungsten, molybdenum disilicide (MoSi₂), molybdenum silicide (MoSi), molybdenum disilicide doped with aluminum (Mo(Si,Al)₂), titanium, platinum, silver, palladium, alloys of silver and palladium, graphite and graphite-based materials (e.g., carbon-based foams and yarns), conductive inks, boron doped silica, and ceramics (e.g., positive or negative temperature coefficient ceramics). The heater 134 may be resistive heating element or a heating element configured to generate heat through induction. The heater 134 may be coated by heat conductive ceramics such as aluminum nitride, silicon carbide, beryllium oxide, alumina, silicon nitride, or their composites.

An opening 128 may be present in the cartridge shell 103 (e.g., at the mouthend) to allow for egress of formed aerosol from the cartridge 104. Such components are representative of the components that may be present in a cartridge and are not intended to limit the scope of cartridge components that are encompassed by the present disclosure.

The cartridge 104 also may include one or more electronic components 150, which may include an integrated circuit, a memory component, a sensor, or the like. The electronic component 150 may be adapted to communicate with the control component 106 and/or with an external device by wired or wireless means. The electronic component 150 may be positioned anywhere within the cartridge 104 or its base 140.

Although the control component 106 and the flow sensor 108 are illustrated separately, it is understood that the control component and the flow sensor may be combined as an electronic circuit board with the air flow sensor attached directly thereto. Further, the electronic circuit board may be positioned horizontally relative the illustration of FIG. 1 in that the electronic circuit board can be lengthwise parallel to the central axis of the power unit. In some embodiments, the air flow sensor may comprise its own circuit board or other base element to which it can be attached. In some embodiments, a flexible circuit board may be utilized. A flexible circuit board may be configured into a variety of shapes, include substantially tubular shapes. Configurations of a printed circuit board and a pressure sensor, for example, are described in U.S. Pat. No. 9,839,238 to Worm et al., the disclosure of which is incorporated herein by reference.

The power unit 102 and the cartridge 104 may include components adapted to facilitate a fluid engagement therebetween. As illustrated in FIG. 1, the power unit 102 can include a coupler 124 having a cavity 125 therein. The cartridge 104 can include a base 140 adapted to engage the coupler 124 and can include a projection 141 adapted to fit within the cavity 125. Such engagement can facilitate a stable connection between the power unit 102 and the cartridge 104 as well as establish an electrical connection between the battery 110 and control component 106 in the power unit and the heater 134 in the cartridge. Further, the power unit shell 101 can include an air intake 118, which may be a notch in the shell where it connects to the coupler 124 that allows for passage of ambient air around the coupler and into the shell where it then passes through the cavity 125 of the coupler and into the cartridge through the projection 141.

A coupler and a base useful according to the present disclosure are described in U.S. Pat. No. 9,609,893 to Novak et al., the disclosure of which is incorporated herein by reference in its entirety. For example, a coupler as seen in FIG. 1 may define an outer periphery 126 configured to mate with an inner periphery 142 of the base 140. In one embodiment the inner periphery of the base may define a radius that is substantially equal to, or slightly greater than, a radius of the outer periphery of the coupler. Further, the coupler 124 may define one or more protrusions 129 at the outer periphery 126 configured to engage one or more recesses 178 defined at the inner periphery of the base. However, various other embodiments of structures, shapes, and components may be employed to couple the base to the coupler. In some embodiments the connection between the base 140 of the cartridge 104 and the coupler 124 of the power unit 102 may be substantially permanent, whereas in other embodiments the connection therebetween may be releasable such that, for example, the power unit may be reused with one or more additional cartridges that may be disposable and/or refillable.

The aerosol delivery device 100 may be substantially rod-like or substantially tubular shaped or substantially cylindrically shaped in some embodiments. In other embodiments, further shapes and dimensions are encompassed—e.g., a rectangular or triangular cross-section, multifaceted shapes, or the like. In particular, the power unit 102 may be non-rod-like and may rather be substantially rectangular, round, or have some further shape. Likewise, the power unit 102 may be substantially larger than a power unit that would be expected to be substantially the size of a conventional cigarette.

The reservoir 144 illustrated in FIG. 1 can be a container (e.g., formed of walls substantially impermeable to the aerosol precursor composition) or can be a fibrous reservoir. Container walls can be flexible and can be collapsible. Container walls alternatively can be substantially rigid. A container preferably is substantially sealed to prevent passage of aerosol precursor composition therefrom except via any specific opening provided expressly for passage of the aerosol precursor composition, such as through a transport element as otherwise described herein. In exemplary embodiments, the reservoir 144 can comprise one or more layers of nonwoven fibers substantially formed into the shape of a tube encircling the interior of the cartridge shell 103. An aerosol precursor composition can be retained in the reservoir 144. Liquid components, for example, can be sorptively retained by the reservoir 144 (i.e., when the reservoir 144 includes a fibrous material). The reservoir 144 can be in fluid connection with a liquid transport element 136. The liquid transport element 136 can transport the aerosol precursor composition stored in the reservoir 144 via capillary action to the heating element 134 that is in the form of a metal wire coil in this embodiment. As such, the heating element 134 is in a heating arrangement with the liquid transport element 136. The heating element 134 is not limited to resistive heating elements in direct electrical contact with the power source 110, but can also include inductive heating elements configured to generate heat as the result of eddy currents created in the presence of an alternating magnetic field.

In use, when a user draws on the article 100, airflow is detected by the sensor 108, the heating element 134 is activated, and the components for the aerosol precursor composition are vaporized by the heating element 134. Drawing upon the mouthend of the article 100 causes ambient air to enter the air intake 118 and pass through the cavity 125 in the coupler 124 and the central opening in the projection 141 of the base 140. In the cartridge 104, the drawn air combines with the formed vapor to form an aerosol. The aerosol is whisked, aspirated, or otherwise drawn away from the heating element 134 and out the mouth opening 128 in the mouthend of the article 100. Alternatively, in the absence of an airflow sensor, the heating element 134 may be activated manually, such as by a push button.

An input element may be included with the aerosol delivery device (and may replace or supplement an airflow or pressure sensor). The input may be included to allow a user to control functions of the device and/or for output of information to a user. Any component or combination of components may be utilized as an input for controlling the function of the device. For example, one or more pushbuttons may be used as described in U.S. Pat. No. 9,839,238 to Worm et al., which is incorporated herein by reference. Likewise, a touchscreen may be used as described in U.S. Pat. App. Pub. No. 2016/0262454, to Sears et al., which is incorporated herein by reference. As a further example, components adapted for gesture recognition based on specified movements of the aerosol delivery device may be used as an input. See U.S. Pub. 2016/0158782 to Henry et al., which is incorporated herein by reference. As still a further example, a capacitive sensor may be implemented on the aerosol delivery device to enable a user to provide input, such as by touching a surface of the device on which the capacitive sensor is implemented.

In some embodiments, an input may comprise a computer or computing device, such as a smartphone or tablet. In particular, the aerosol delivery device may be wired to the computer or other device, such as via use of a USB cord or similar protocol. The aerosol delivery device also may communicate with a computer or other device acting as an input via wireless communication. See, for example, the systems and methods for controlling a device via a read request as described in U.S. Pub. No. 2016/0007561 to Ampolini et al., the disclosure of which is incorporated herein by reference. In such embodiments, an APP or other computer program may be used in connection with a computer or other computing device to input control instructions to the aerosol delivery device, such control instructions including, for example, the ability to form an aerosol of specific composition by choosing the nicotine content and/or content of further flavors to be included.

The various components of an aerosol delivery device according to the present disclosure can be chosen from components described in the art and commercially available. Examples of batteries that can be used according to the disclosure are described in U.S. Pat. No. 9,484,155 to Peckerar et al., the disclosure of which is incorporated herein by reference in its entirety.

The aerosol delivery device can incorporate a sensor or detector for control of supply of electric power to the heat generation element when aerosol generation is desired (e.g., upon draw during use). As such, for example, there is provided a manner or method for turning off the power supply to the heat generation element when the aerosol delivery device is not be drawn upon during use, and for turning on the power supply to actuate or trigger the generation of heat by the heat generation element during draw. Additional representative types of sensing or detection mechanisms, structure and configuration thereof, components thereof, and general methods of operation thereof, are described in U.S. Pat. No. 5,261,424 to Sprinkel, Jr.; U.S. Pat. No. 5,372,148 to McCafferty et al.; and PCT WO 2010/003480 to Flick; which are incorporated herein by reference.

The aerosol delivery device most preferably incorporates a control mechanism for controlling the amount of electric power to the heat generation element during draw. Representative types of electronic components, structure and configuration thereof, features thereof, and general methods of operation thereof, are described in U.S. Pat. No. 4,735,217 to Gerth et al.; U.S. Pat. No. 4,947,874 to Brooks et al.; U.S. Pat. No. 5,372,148 to McCafferty et al.; U.S. Pat. No. 6,040,560 to Fleischhauer et al.; U.S. Pat. No. 7,040,314 to Nguyen et al.; U.S. Pat. No. 8,205,622 to Pan; U.S. Pat. No. 8,881,737 to Collet et al; U.S. Pat. No. 9,423,152 to Ampolini et al.; U.S. Pat. No. 9,439,454 to Fernando et al.; and U.S. Pat. Pub. No. 2015/0257445 to Henry et al.; which are incorporated herein by reference.

Representative types of substrates, reservoirs or other components for supporting the aerosol precursor are described in U.S. Pat. No. 8,528,569 to Newton; U.S. Pat. Pub. Nos. 2014/0261487 to Chapman et al., and 2015/0216232 to Bless et al.; which are incorporated herein by reference. Additionally, various wicking materials, and the configuration and operation of those wicking materials within certain types of electronic cigarettes, are set forth in U.S. Pat. No. 8,910,640 to Sears et al.; which is incorporated herein by reference.

For aerosol delivery systems that are characterized as electronic cigarettes, the aerosol precursor composition most preferably incorporates tobacco or components derived from tobacco. In one regard, the tobacco may be provided as parts or pieces of tobacco, such as finely ground, milled or powdered tobacco lamina. In another regard, the tobacco may be provided in the form of an extract (e.g., an extract from which the nicotine is derived), such as a spray dried extract that incorporates many of the water soluble components of tobacco. Alternatively, tobacco extracts may have the form of relatively high nicotine content extracts, which extracts also incorporate minor amounts of other extracted components derived from tobacco. In another regard, components derived from tobacco may be provided in a relatively pure form, such as certain flavoring agents that are derived from tobacco. In one regard, a component that is derived from tobacco, and that may be employed in a highly purified or essentially pure form, is nicotine (e.g., pharmaceutical grade nicotine).

The aerosol precursor composition, also referred to as a vapor precursor composition, may comprise a variety of components including, by way of example, a polyhydric alcohol (e.g., glycerin, propylene glycol, or a mixture thereof), nicotine, tobacco, tobacco extract, and/or flavorants. Most preferably, the aerosol precursor composition is comprised of a combination or mixture of various ingredients or components. The selection of the particular aerosol precursor components, and the relative amounts of those components used, may be altered in order to control the overall chemical composition of the mainstream aerosol produced by the aerosol generation arrangement(s). Of particular interest are aerosol precursor compositions that can be characterized as being generally liquid in nature. For example, representative generally liquid aerosol precursor compositions may have the form of liquid solutions, viscous gels, mixtures of miscible components, or liquids incorporating suspended or dispersed components. Typical aerosol precursor compositions are capable of being vaporized upon exposure to heat under those conditions that are experienced during use of the aerosol generation arrangement(s) that are characteristic of the present disclosure; and hence are capable of yielding vapors and aerosols that are capable of being inhaled.

According to some aspects, the aerosol delivery device may include or incorporate tobacco, a tobacco component, or a tobacco-derived material (i.e., a material that is found naturally in tobacco that may be isolated directly from the tobacco or synthetically prepared). For example, the aerosol delivery device may include an amount of flavorful and aromatic tobaccos in cut filler form. In some aspects, the aerosol precursor composition may include tobacco, a tobacco component, or a tobacco-derived material that is processed to provide a desired quality, such as those processed according to methods described in U.S. Pat. No. 9,066,538 to Chen et al.; U.S. Pat. Nos. 9,155,334 and 9,681,681 to Moldoveanu et al.; and U.S. Pat. No. 9,980,509 to Marshall et al.; the disclosures of which are incorporated in their entirety herein by reference.

As noted above, highly purified tobacco-derived nicotine (e.g., pharmaceutical grade nicotine having a purity of greater than 98% or greater than 99%) or a derivative thereof can be used in the devices of the present disclosure. Representative nicotine-containing extracts can be provided using the techniques set forth in U.S. Pat. No. 5,159,942 to Brinkley et al., which is incorporated herein by reference. In certain embodiments, the products of the present disclosure can include nicotine in any form from any source, whether tobacco-derived or synthetically-derived. Nicotinic compounds used in the products of the present disclosure can include nicotine in free base form, salt form, as a complex, or as a solvate. See, for example, the discussion of nicotine in free base form in U.S. Pat. No. 8,771,348 to Hansson, which is incorporated herein by reference. At least a portion of the nicotinic compound can be employed in the form of a resin complex of nicotine where nicotine is bound in an ion exchange resin such as nicotine polacrilex. See, for example, U.S. Pat. No. 3,901,248 to Lichtneckert et al.; which is incorporated herein by reference. At least a portion of the nicotine can be employed in the form of a salt. Salts of nicotine can be provided using the types of ingredients and techniques set forth in U.S. Pat. No. 2,033,909 to Cox et al. and Perfetti, Beitrage Tabakforschung Int., 12, 43-54 (1983). Additionally, salts of nicotine have been available from sources such as Pfaltz and Bauer, Inc. and K&K Laboratories, Division of ICN Biochemicals, Inc. Exemplary pharmaceutically acceptable nicotine salts include nicotine salts of tartrate (e.g., nicotine tartrate and nicotine bitartrate), chloride (e.g., nicotine hydrochloride and nicotine dihydrochloride), sulfate, perchlorate, ascorbate, fumarate, citrate, malate, lactate, aspartate, salicylate, tosylate, succinate, pyruvate, and the like; nicotine salt hydrates (e.g., nicotine zinc chloride monohydrate), and the like. In certain embodiments, at least a portion of the nicotinic compound is in the form of a salt with an organic acid moiety, including, but not limited to, levulinic acid as discussed in U.S. Pat. Pub. No. 2011/0268809 to Brinkley et al., which are incorporated herein by reference.

In another aspect, the aerosol precursor composition may include tobacco, a tobacco component, or a tobacco-derived material that may be treated, manufactured, produced, and/or processed to incorporate an aerosol-forming material (e.g., humectants such as, for example, propylene glycol, glycerin, and/or the like). Additionally or alternatively, the aerosol precursor composition may include at least one flavoring agent. Additional components that may be included in the aerosol precursor composition are described in U.S. Pat. No. 7,726,320 to Robinson et al., which is incorporated herein by reference. Various manners and methods for incorporating tobacco and other ingredients into aerosol generating devices are set forth in U.S. Pat. No. 4,947,874 to Brooks et al.; U.S. Pat. No. 7,290,549 to Banerjee et al; U.S. Pat. No. 7,647,932 to Cantrell et al.; U.S. Pat. No. 8,079,371 to Robinson et al.; and U.S. Pat. App. Pub. Nos. 2007/0215167 to Crooks et al.; 2016/0073695 to Sears et al., the disclosures of which are incorporated herein by reference in their entirety.

The aerosol precursor composition may also incorporate so-called “aerosol forming materials.” Such materials may, in some instances, have the ability to yield visible (or not visible) aerosols when vaporized upon exposure to heat under those conditions experienced during normal use of aerosol generation arrangement(s) that are characteristic of the present disclosure. Such aerosol forming materials include various polyols or polyhydric alcohols (e.g., glycerin, propylene glycol, and mixtures thereof). Aspects of the present disclosure also incorporate aerosol precursor components that can be characterized as water, saline, moisture or aqueous liquid. During conditions of normal use of certain aerosol generation arrangement(s), the water incorporated within those aerosol generation arrangement(s) can vaporize to yield a component of the generated aerosol. As such, for purposes of the current disclosure, water that is present within the aerosol precursor composition may be considered to be an aerosol forming material.

It is possible to employ a wide variety of optional flavoring agents or materials that alter the sensory character or nature of the drawn mainstream aerosol generated by the aerosol delivery system of the present disclosure. For example, such optional flavoring agents may be used within the aerosol precursor composition or substance to alter the flavor, aroma and organoleptic properties of the aerosol. Certain flavoring agents may be provided from sources other than tobacco. Exemplary flavoring agents may be natural or artificial in nature, and may be employed as concentrates or flavor packages.

Exemplary flavoring agents include vanillin, ethyl vanillin, cream, tea, coffee, fruit (e.g., apple, cherry, strawberry, peach and citrus flavors, including lime and lemon), maple, menthol, mint, peppermint, spearmint, wintergreen, nutmeg, clove, lavender, cardamom, ginger, honey, anise, sage, cinnamon, sandalwood, jasmine, cascarilla, cocoa, licorice, and flavorings and flavor packages of the type and character traditionally used for the flavoring of cigarette, cigar and pipe tobaccos. Syrups, such as high fructose corn syrup, also can be employed. Certain flavoring agents may be incorporated within aerosol forming materials prior to formulation of a final aerosol precursor mixture (e.g., certain water soluble flavoring agents can be incorporated within water, menthol can be incorporated within propylene glycol, and certain complex flavor packages can be incorporated within propylene glycol). However, in some aspects of the present disclosure, the aerosol precursor composition is free of any flavorants, flavor characteristics or additives.

Aerosol precursor compositions also may include ingredients that exhibit acidic or basic characteristics (e.g., organic acids, ammonium salts or organic amines). For example, certain organic acids (e.g., levulinic acid, succinic acid, lactic acid, and pyruvic acid) may be included in an aerosol precursor formulation incorporating nicotine, preferably in amounts up to being equimolar (based on total organic acid content) with the nicotine. For example, the aerosol precursor may include about 0.1 to about 0.5 moles of levulinic acid per one mole of nicotine, about 0.1 to about 0.5 moles of succinic acid per one mole of nicotine, about 0.1 to about 0.5 moles of lactic acid per one mole of nicotine, about 0.1 to about 0.5 moles of pyruvic acid per one mole of nicotine, or various permutations and combinations thereof, up to a concentration wherein the total amount of organic acid present is equimolar to the total amount of nicotine present in the aerosol precursor composition. However, in some aspects of the present disclosure, the aerosol precursor composition is free of any acidic (or basic) characteristics or additives.

As one non-limiting example, a representative aerosol precursor composition or substance can include glycerin, propylene glycol, water, saline, and nicotine, and combinations or mixtures of any or all of those components. For example, in one instance, a representative aerosol precursor composition may include (on a weight basis) about 70% to about 100% glycerin, and often about 80% to about 90% glycerin; about 5% to about 25% water, often about 10% to about 20% water; and about 0.1% to about 5% nicotine, often about 2% to about 3% nicotine. In one particular non-limiting example, a representative aerosol precursor composition may include about 84% glycerin, about 14% water, and about 2% nicotine. The representative aerosol precursor composition may also include propylene glycol, optional flavoring agents or other additives in varying amounts on a weight basis. In some instances, the aerosol precursor composition may comprise up to about 100% by weight of any of glycerin, water, and saline, as necessary or desired.

The aerosol precursor composition, also referred to as a vapor precursor composition or “e-liquid”, may comprise a variety of components including, by way of example, a polyhydric alcohol (e.g., glycerin, propylene glycol, or a mixture thereof), nicotine, tobacco, tobacco extract, and/or flavorants. Representative types of aerosol precursor components and formulations also are set forth and characterized in U.S. Pat. No. 7,217,320 to Robinson et al.; U.S. Pat. No. 8,881,737 to Collett et al.; U.S. Pat. No. 9,254,002 to Chong et al.; and U.S. Pat. Pub. Nos. 2013/0008457 to Zheng et al.; 2015/0020823 to Lipowicz et al.; and 2015/0020830 to Koller, as well as WO 2014/182736 to Bowen et al, the disclosures of which are incorporated herein by reference. Other aerosol precursors that may be employed include the aerosol precursors that have been incorporated in VUSE® products by R. J. Reynolds Vapor Company, the BLU™ products by Fontem Ventures B.V., the MISTIC MENTHOL product by Mistic Ecigs, MARK TEN products by Nu Mark LLC, the JUUL product by Juul Labs, Inc., and VYPE products by CN Creative Ltd. Also desirable are the so-called “smoke juices” for electronic cigarettes that have been available from Johnson Creek Enterprises LLC. Still further example aerosol precursor compositions are sold under the brand names BLACK NOTE, COSMIC FOG, THE MILKMAN E-LIQUID, FIVE PAWNS, THE VAPOR CHEF, VAPE WILD, BOOSTED, THE STEAM FACTORY, MECH SAUCE, CASEY JONES MAINLINE RESERVE, MITTEN VAPORS, DR. CRIMMY'S V-LIQUID, SMILEY E LIQUID, BEANTOWN VAPOR, CUTTWOOD, CYCLOPS VAPOR, SICBOY, GOOD LIFE VAPOR, TELEOS, PINUP VAPORS, SPACE JAM, MT. BAKER VAPOR, and JIMMY THE JUICE MAN.

The amount of aerosol precursor that is incorporated within the aerosol delivery system is such that the aerosol generating piece provides acceptable sensory and desirable performance characteristics. For example, it is desired that sufficient amounts of aerosol forming material (e.g., glycerin and/or propylene glycol), be employed in order to provide for the generation of a visible mainstream aerosol that in many regards resembles the appearance of tobacco smoke. The amount of aerosol precursor within the aerosol generating system may be dependent upon factors such as the number of puffs desired per aerosol generating piece. In one or more embodiments, about 0.5 ml or more, about 1 ml or more, about 2 ml or more, about 5 ml or more, or about 10 ml or more of the aerosol precursor composition may be included.

Yet other features, controls or components that can be incorporated into aerosol delivery systems of the present disclosure are described in U.S. Pat. No. 5,967,148 to Harris et al.; U.S. Pat. No. 5,934,289 to Watkins et al.; U.S. Pat. No. 5,954,979 to Counts et al.; U.S. Pat. No. 6,040,560 to Fleischhauer et al.; U.S. Pat. No. 8,365,742 to Hon; U.S. Pat. No. 8,402,976 to Fernando et al.; U.S. Pat. No. 8,689,804 to Fernando et al.; U.S. Pat. No. 9,220,302 to DePiano et al.; U.S. Pat. No. 9,427,022 to Levin et al.; U.S. Pat. No. 9,510,623 to Tucker et al.; U.S. Pat. No. 9,609,893 to Novak et al.; and U.S. Pat. No. 10,004,259 to Sebastian et al.; and U.S. Pat. Pub. No. 2013/0180553 to Kim et al., which are incorporated herein by reference.

The foregoing description of the use of the article can be applied to the various embodiments described herein through minor modifications, which can be apparent to the person of skill in the art in light of the further disclosure provided herein. The above description of use, however, is not intended to limit the use of the article but is provided to comply with all necessary requirements of disclosure of the present disclosure. Any of the elements shown in the article illustrated in FIG. 1 or as otherwise described above may be included in an aerosol delivery device according to the present disclosure.

In one or more embodiments, the present disclosure can relate to the use of a monolithic material in one or more components of an aerosol delivery device. As used herein, a “monolithic material” or “monolith” is intended to mean comprising a substantially single unit which, in some embodiments, may be a single piece formed, composed, or created without joints or seams and comprising a substantially, but not necessarily rigid, uniform whole. In some embodiments, a monolith according to the present disclosure may be undifferentiated, i.e., formed of a single material, or may be formed of a plurality of units that are permanently combined, such as a sintered conglomerate. Thus, in some embodiments the porous monolith may comprise an integral porous monolith.

In some embodiments, the use of a monolith particularly can relate to the use of a porous glass monolith in components of an aerosol delivery device. As used herein, “porous glass” is intended to refer to glass that has a three-dimensional interconnected porous microstructure. The term specifically can exclude materials made of bundles (i.e., wovens or non-wovens) of glass fibers. Thus, porous glass can exclude fibrous glass. Porous glass may also be referred to as controlled pore glass (CPG) and may be known by the trade name VYCOR®. Porous glass suitable for use according to the present disclosure can be prepared by known methods such as, for example, metastable phase separation in borosilicate glasses followed by liquid extraction (e.g., acidic extraction or combined acidic and alkaline extraction) of one of the formed phases, via a sol-gel process, or by sintering of glass powder. The porous glass particularly can be a high-silica glass, such as comprising 90% or greater, 95%, 96% or greater, or 98% or greater silica by weight. Porous glass materials and methods of preparing porous glass that can be suitable for use according to the present disclosure are described in U.S. Pat. No. 2,106,744 to Hood et al., U.S. Pat. No. 2,215,039 to Hood et al., U.S. Pat. No. 3,485,687 to Chapman et al., U.S. Pat. No. 4,657,875 to Nakashima et al., U.S. Pat. No. 9,003,833 to Kotani et al., U.S. Pat. No. 9,321,675 to Himanshu, U.S. Pat. Pub. No. 2013/0045853 to Kotani et al., U.S. Pat. Pub. No. 2013/0067957 to Zhang et al., and U.S. Pat. Pub. No. 2013/0068725 to Takashima et al., the disclosures of which are incorporated herein by reference. Although the term porous “glass” may be used herein, it should not be construed as limiting the scope of the disclosure in that a “glass” can encompass a variety of silica based materials.

The porous glass can be defined in some embodiments in relation to its average pore size. For example, the porous glass can have an average pore size of about 1 nm to about 1000 about 2 nm to about 500 about 5 nm to about 200 or about 10 nm to about 100 In certain embodiments, porous glass for use according to the present disclosure can be differentiated based upon the average pore size. For example, a small pore porous glass can have an average pore size of 1 nm up to 500 nm, an intermediate pore porous class can have an average pore size of 500 nm up to 10 and a large pore porous glass can have an average pore size of 10 μm up to 1000 In some embodiments, a large pore porous glass can preferably be useful as a storage element, and a small pore porous glass and/or an intermediate pore porous glass can preferably be useful as a transport element.

The porous glass also can be defined in some embodiments in relation to its surface area. For example, the porous glass can have a surface area of at least 100 m²/g, at least 150 m²/g, at least 200 m²/g, or at least 250 m²/g, such as about 100 m²/g to about 600 m²/g, about 150 m²/g to about 500 m²/g, or about 200 m²/g to about 450 m²/g.

The porous glass can be defined in some embodiments in relation to its porosity (i.e., the volumetric fraction of the material defining the pores). For example, the porous glass can have a porosity of at least 20%, at least 25%, or at least 30%, such as about 20% to about 80%, about 25% to about 70%, or about 30% to about 60% by volume. In certain embodiments, a lower porosity may be desirable, such as a porosity of about 5% to about 50%, about 10% to about 40%, or about 15% to about 30% by volume.

The porous glass can be further defined in some embodiments in relation to its density. For example, the porous glass can have a density of 0.25 g/cm³ to about 3 g/cm³, about 0.5 g/cm³ to about 2.5 g/cm³, or about 0.75 g/cm³ to about 2 g/cm³.

In some embodiments, the use of a monolith particularly can relate to the use of a porous ceramic monolith in components of an aerosol delivery device. As used herein, “porous ceramic” is intended to refer to a ceramic material that has a three-dimensional interconnected porous microstructure. Porous ceramic materials and methods of making porous ceramics suitable for use according to the present disclosure are described in U.S. Pat. No. 3,090,094 to Schwartzwalder et al., U.S. Pat. No. 3,833,386 to Frisch et al., U.S. Pat. No. 4,814,300 to Helferich, U.S. Pat. No. 5,171,720 to Kawakami, U.S. Pat. No. 5,185,110 to Kunikazu et al., U.S. Pat. No. 5,227,342 to Anderson et al., U.S. Pat. No. 5,645,891 to Liu et al., U.S. Pat. No. 5,750,449 to Niihara et al., U.S. Pat. No. 6,753,282 to Fleischmann et al., U.S. Pat. No. 7,208,108 to Otsuka et al., U.S. Pat. No. 7,537,716 to Matsunaga et al., U.S. Pat. No. 8,609,235 to Hotta et al., the disclosures of which are incorporated herein by reference. Although the term porous “ceramic” may be used herein, it should not be construed as limiting the scope of the disclosure in that a “ceramic” can encompass a variety of alumina based materials.

The porous ceramic likewise can be defined in some embodiments in relation to its average pore size. For example, the porous ceramic can have an average pore size of about 1 nm to about 1000 about 2 nm to about 500 about 5 nm to about 200 or about 10 nm to about 100 In certain embodiments, porous ceramic for use according to the present disclosure can be differentiated based upon the average pore size. For example, a small pore porous ceramic can have an average pore size of 1 nm up to 500 nm, an intermediate pore porous ceramic can have an average pore size of 500 nm up to 10 and a large pore porous ceramic can have an average pore size of 10 μm up to 1000 In some embodiments, a large pore porous ceramic can preferably be useful as a storage element, and a small pore porous ceramic and/or an intermediate pore porous ceramic can preferably be useful as a transport element.

The porous ceramic also can be defined in some embodiments in relation to its surface area. For example, the porous ceramic can have a surface area of at least 100 m²/g, at least 150 m²/g, at least 200 m²/g, or at least 250 m²/g, such as about 100 m²/g to about 600 m²/g, about 150 m²/g to about 500 m²/g, or about 200 m²/g to about 450 m²/g.

The porous ceramic can be defined in some embodiments in relation to its porosity (i.e., the volumetric fraction of the material defining the pores). For example, the porous ceramic can have a porosity of at least 20%, at least 25%, or at least 30%, or at least 40%, such as about 20% to about 80%, about 25% to about 70%, about 30% to about 60%, or about 40% to about 50% by volume. In certain embodiments, a lower porosity may be desirable, such as a porosity of about 5% to about 50%, about 10% to about 40%, or about 15% to about 30% by volume.

The porous ceramic can be further defined in some embodiments in relation to its density. For example, the porous ceramic can have a density of 0.1 g/cm³ to about 3 g/cm³, about 0.5 g/cm³ to about 2.5 g/cm³, or about 0.75 g/cm³ to about 2 g/cm³.

Although silica-based materials (e.g., porous glass) and alumina-based materials (e.g., porous ceramic) may be discussed separately herein, it is understood that a porous monolith, in some embodiments, can comprise a variety of aluminosilicate materials. For example, various zeolites may be utilized according to the present disclosure. Thus, by way of example, the porous monoliths discussed herein may comprise one or both of a porous glass and a porous ceramic, which may be provided as a composite. In one embodiment such a composite may comprise SiO₂ and Al₂O₃. Other suitable materials to form at least a portion of the composite include ZnO, ZrO₂, CuO, MgO, and/or other metal oxides.

In one or more embodiments, a porous monolith according to the present disclosure can be characterized in relation to wicking rate. As a non-limiting example, wicking rate can be calculated by measuring the mass uptake of a known liquid, and the rate (in mg/s) can be measured using a microbalance tensiometer or similar instrument. Preferably, the wicking rate is substantially within the range of the desired mass of aerosol to be produced over the duration of a puff on an aerosol forming article including the porous monolith. Wicking rate can be, for example, in the range of about 0.01 mg/s to about 20 mg/s, about 0.1 mg/s to about 12 mg/s, or about 0.5 mg/s to about 10 mg/s. Wicking rate can vary based upon the liquid being wicked. In some embodiments, wicking rates as described herein can be referenced to substantially pure water, substantially pure glycerol, substantially pure propylene glycol, a mixture of water and glycerol, a mixture of water and propylene glycol, a mixture of glycerol and propylene glycol, or a mixture of water, glycerol, and propylene glycol. Wicking rate also can vary based upon the use of the porous monolith. For example, a porous monolith used as a liquid transport element may have a greater wicking rate than a porous monolith used as a reservoir. Wicking rates may be varied by control of one or more of pore size, pore size distribution, and wettability, as well as the composition of the material being wicked.

As noted above, some existing embodiments of aerosol delivery devices comprise a liquid transport element and/or a reservoir comprising a fibrous material. However, fibrous materials may suffer from certain detriments. In this regard, in view of the heating element being positioned in proximity to the liquid transport element, scorching could occur at the fibrous liquid transport element which could detrimentally affect the flavor of the aerosol produced and/or the structural integrity of the liquid transport element. Depending on the relative position of the components, scorching could also occur at the fibrous reservoir.

Further, fibrous materials may in general be relatively weak and prone to tearing or other failure when subjected stresses such as may occur during repeated drop events or other severe incidents. Additionally, usage of fibrous materials in the air flow path may present challenges during assembly in terms of ensuring that no loose fibers are present. Due to the flexible nature of fibrous materials, it may also be difficult to form, and retain, the liquid transport element and the reservoir in desired shapes.

Accordingly, the use of a rigid monolith as a fluid transport element is beneficial for improving uniformity of heating and reducing possible charring of the fluid transport element when non-uniform heating occurs. Further, a relatively more durable material such as a porous glass or porous ceramic, compared to a fibrous material may be selected, which may not tear. Further, such a material may not be subject to scorching. Additionally, the absence of fibers in porous monoliths eliminates issues with respect movement of fibers in the airflow path defined therethrough.

Despite such benefits, monoliths also present certain challenges for successful implementation as a fluid transport element. Such challenges are in part due to the different material properties of monoliths (e.g., porous ceramics) compared to fibrous wicks. For example, alumina has both a higher thermal conductivity and a higher heat capacity than silica. These thermal properties cause heat to be drawn away from the aerosol precursor composition at the interface of the wick and the heater, and this can require a higher initial energy output to achieve comparable fluid vaporization. The present disclosure realizes means for overcoming such difficulties.

In some embodiments utilizing a porous monolith, energy requirements for vaporization when using a porous monolith can be minimized, and vaporization response time can be improved by increasing heat flux density (measured in Watts per square meter—W/m²) over the surface of the porous monolith fluid transport element. The present disclosure particularly describes embodiments suitable to provide such increase in heat flux density.

In some embodiments, a liquid transport element (i.e., a wick or wicking element) can be formed partially or completely from a ceramic material, particularly a porous ceramic. Exemplary ceramic materials suitable for use according to embodiments of the present disclosure are described, for example, in U.S. Pat. App. Pub. Nos. 2014/0123989 to LaMothe, and 2017/0188626 to Davis et al., the disclosures of which are incorporated herein by reference. The porous ceramic can form a substantially solid wick—i.e., being a single, monolithic material rather than a bundle of individual fibers as known in the art.

In some embodiments, a heating element can be configured for increased vaporization, such as arising from an increased heating temperature, which can be tolerated because of the use of the ceramic wick, or arising from a larger heating surface (e.g., having a greater number of coils of a resistance heating wire wrapped around a ceramic wick). The heating element can combine with a liquid transport element to form an atomizer.

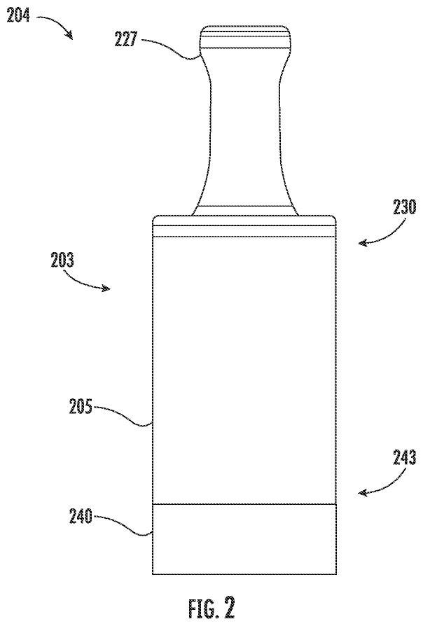

FIG. 2 illustrates a vapor-forming unit 204 (e.g., a cartridge) according to another general embodiment, which can comprise a housing 203 that is formed at least in part by an outer wall 205. The vapor-forming unit 204 can further comprise a connector 240 that can be positioned at a connector end 243 of the housing 203. A mouthpiece 227 can be positioned at a mouthend 230 of the housing 203.

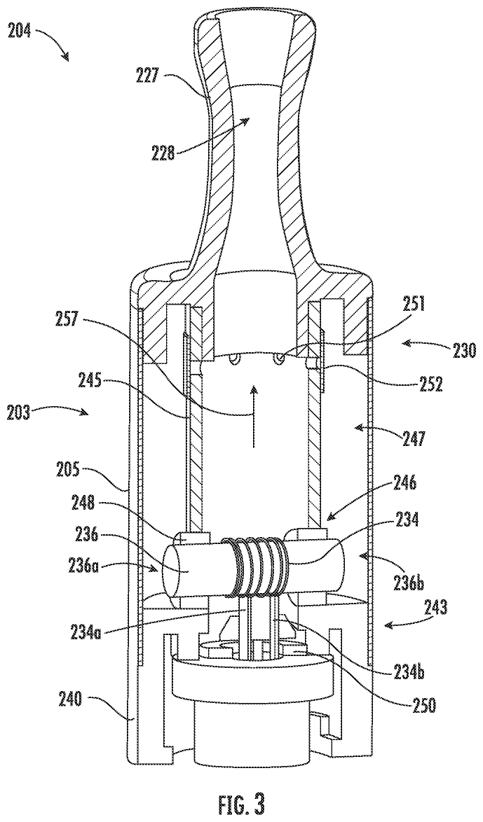

The internal construction of the vapor-forming unit 204 is evident in FIG. 3. In particular, a flow tube 245 is positioned interior to the outer wall 205 of the housing 203. The flow tube 245 can be formed of any suitable material, such as metal, polymer, ceramic compositions. The flow tube 245 is preferably formed of a material that does not degrade under temperatures achieved proximate the heater and is thus heat stable. The arrangement of the flow tube 245 and the outer wall 205 of the housing 203 can define an annular space 247 therebetween. The annular space 247 can function effectively as a reservoir for an aerosol precursor composition. The annular space 247 can be substantially empty of other materials apart from the aerosol precursor composition. In some embodiments, however, a fibrous material can be included in the annular space 247 if desired to sorptively retain at least a portion of the aerosol precursor composition. An airflow path 257 can be present through the vapor-forming unit 204 and can be present particularly between the connector end 243 of the housing 203 and the mouthend 230 of the housing 203. The airflow path 257 extends at least partially through the flow tube 245. The airflow path 257, however, also can extend through additional elements of the device, such as through an internal channel 228 of the mouthpiece 227 and/or the connector 240. Connectors and airflow paths therethrough suitable for use according to the present disclosure are described in U.S. Pat. No. 9,839,238 to Worm et al., which is incorporated herein by reference.

The vapor-forming unit 204 of FIG. 3 can further include a heater 234 and a wick 236 that collectively can be characterized as an atomizer or atomizer unit. The heater 234 and wick 236 interact with the flow tube 245 such that aerosol precursor composition in the annular space 247 is transported via the wick to the heater where it is vaporized within the flow tube or within a space that is in fluid communication with the flow tube (e.g., being immediately adjacent an end of the flow tube. Accordingly, at least a portion of the wick 236 is in the airflow path 257 and at least a portion of the wick is in fluid communication with the annular space 247. The interaction between the wick 236 and the flow tube 245 can be characterized as a sealing engagement in that the wick can pass through an opening 246 formed in the flow tube in a manner such that aerosol precursor composition from the annular space 247 is substantially prevented from passing through the opening apart from passage through the wick itself.

In some embodiments, a sealing engagement may be facilitated by use of a sealing member 248 that can be positioned between the wick 236 and the flow tube 247. The sealing member 248 can engage the wick 236 and the flow tube 245 in a variety of manners, and only a single sealing member or a plurality of sealing members can be utilized. An arrangement of the wick 236, flow tube 245, sealing member 248, and connector 240 is illustrated in FIG. 3. In the illustrated embodiment, the wick 236 is essentially positioned between the flow tube 245 and the connector 240. The opening 246 in the flow tube 245 is in the form of a cut-out in the end of the flow tube wall. A corresponding cut-out may be formed in the connector 240. The wick 236 passes through the cut-out on one side or both sides of the flow tube 245, and the sealing member 246 fills any space between the outer surface of the wick and the inner surface of the cut-out in the flow tube (and optionally the connector). As illustrated, the sealing member 246 also functions as a sealing member between the an end of the flow tube 245 and the connector 240 to effectively seal the connection of the two elements. In other words, the flow tube 245 can extend fully between the mouthpiece 227 and the connector 240. The sealing member 248 can be formed of any suitable sealant such as silicone, rubber, or other resilient material.

The flow tube 245 can include a vent that can be formed by one or more vents or vent openings 251. The vent 251 can be configured for pressure equalization within the annular space 247 as liquid is depleted therefrom. In some embodiments, the vent 251 can include a vent cover 252. The vent cover 252 can be formed of a microporous material. Preferably, the vent cover 252 is effective to allow passage of gas (e.g., air) therethrough while substantially preventing the passage of liquid therethrough. The vent may be positioned at various locations along the flow tube 245 and particularly can be provided proximate the interconnection between the flow tube and the mouthpiece 227. The flow tube 245 thus can engage or abut the mouthpiece 227 at a first end of the flow tube and can engage or abut the connector 240 at a second end of the flow tube.

In one or more embodiments, the heater 234 can be in the form of a heating element that can be coiled or otherwise positioned around an exterior surface of the wick 236. The heating element can be a wire or a conductive mesh. The heating element can be configured to generate heat through electrical resistance when in direct electrical communication with a power source. Alternatively, the heating element may generate heat through an inductive heating process as eddy currents are created within the heating element as the result of an alternating magnetic current in the field of the heating element. In either case, vapor is formed around the exterior of the wick 236 to be whisked away by air passing across the wick and the heater 234 and into the airflow path 257. The wick 236 specifically can have a longitudinal axis that is substantially perpendicular to a longitudinal axis of the housing 203. In some embodiments, the wick 236 can extend transversely across the flow tube 245 between a first wick end 236a and a second wick end 236b. Further, the sealing member 248 can be in a sealing engagement with the wick 236 proximate the first wick end 236a and the second wick end 236b. The first and second wick ends (236a, 236b) can extend beyond the sealing member 248 or can be substantially flush with the sealing member so long as the aerosol precursor composition in the annular space 247 is capable of achieving a fluid connection with the wick ends.

In the illustrated example, electrical terminals (234a, 234b) can be in electrical connection with the heater 234 and can extend through the connector 240 so as to facilitate electrical connection with a power source. A printed circuit board (PCB) 250 or the like can be included with the vapor-forming unit 204 and may particularly be positioned within the connector 240 so as to effectively isolate the electronic component from the liquid in the annular space 247 and the vapor (and possible condensed liquid) in the flow tube 245. The PCB 250 can provide control functions for the vapor-forming unit and/or can send/receive information from a controller (see element 106 in FIG. 1) that can be in a further body to which the vapor-forming unit may be connected.

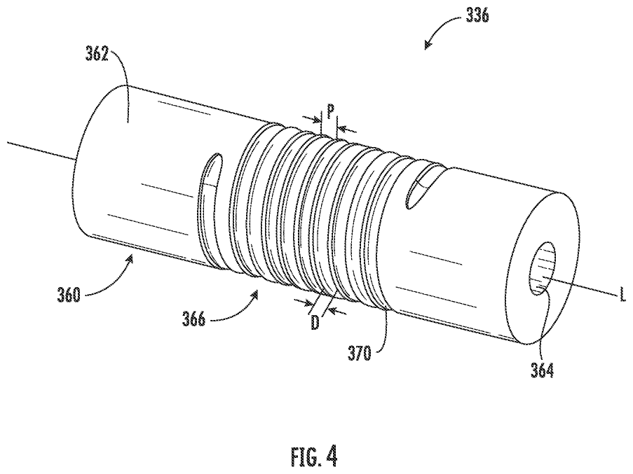

FIG. 4 shows an exemplary embodiment of a liquid transport element 336 (e.g., a wicking element or wick) suitable for use in the either the cartridge 104 of FIG. 1 or the vapor forming unit 204 of FIG. 2. It is understood, however, that the liquid transport element(s) described herein are suitable for use in any number of aerosol forming devices and particularly may be utilized in any device where it is desirable to transport a liquid, particularly a viscous liquid, such as an aerosol precursor composition as described herein, to a heater for vaporization. The liquid transport element 336 may comprise a rigid monolith 360, such as a porous monolith formed from porous glass or porous ceramic as discussed above. At least some of the rigid monolith 360 may be configured substantially as a cylinder with a longitudinal axis L. The rigid monolith 360 includes an exterior surface 362.

In one embodiment, the rigid monolith 360 may include one or more lumen 364 extending substantially parallel with the longitudinal axis L. The one or more lumen 364 may render the rigid monolith 360 substantially hollow. Providing a hollow configuration may be particularly beneficial if the monolith 360 is made from a material with little or no porosity in order to assist wicking. In an embodiment, the wall thickness of the monolith 360 between the exterior surface 362 and an interior surface defined by the lumen 364 may range from about 0.1 mm to about 4 mm, or from about 1 mm to about 2 mm. Other example dimensions of the rigid monolith 360 that may be suitable include an outer diameter defined by the exterior surface 362 of from about 1 mm to about 8 mm, or from about 2 mm to about 4 mm. An inner diameter defined by the lumen 364 may range from about 0.1 mm to about 5 mm, or from about 0.5 mm to about 2 mm. The rigid monolith 360 is not limited to cylindrical shaped bodies. In one example, a length of the rigid monolith 360 that is surrounded by the heater 134, 234 may be from about 2 mm to about 20 mm or from about 3 mm to about 8 mm.

In one embodiment, as shown in FIGS. 1 and 3, a heater 134, 234 is configured to be at least partially wrapped around, and preferably contacting, the exterior surface 362 of the rigid monolith 360. In one embodiment, the heater 134, 234 may be formed integrally with the exterior surface 362 or other portion of the monolith 360. Returning to FIG. 4, the exterior surface 362 is formed or otherwise processed to include at least one surface discontinuity 366. The surface discontinuity 366 may be formed by etching the exterior surface 362 of the liquid transport element 336. The surface discontinuity 366 can be provided after formation of the rigid monolith 360 through other processes known in the art, including boring or other machining processes. Alternatively, the surface discontinuity 366 can be created during formation of the rigid monolith 360 through manufacturing processes such as casting, injection molding, stamping, pressing, extrusion, or additive manufacturing, or other processes which may be particularly useful for creating complex shapes with rigid materials such as glass and ceramic. Prior to use, the rigid monolith may be subject to a sintering process.

The surface discontinuity 366 may be provided in the exterior surface 362 of the liquid transport element 336 to promote increased vaporization. The improvement in vaporization can stem from a variety of factors, including designing the liquid transport element 336 to more efficiently use the heat generated by the heater. The liquid transport element 336 can also provide improved vaporization by increasing the wicking efficiency of the liquid transport element. The surface discontinuity 362 as discussed below is an intentional surface feature which is created according to a predetermined pattern with predetermined spacing and depth as discussed below for properly engaging with the heater.

In the illustrated example of FIG. 4, the surface discontinuity 366 of the liquid transport element 336 is provided in the form of a helical groove 370 formed in a spiral pattern around the longitudinal axis L of at least the cylindrical portion of the rigid monolith 360. The helical groove 370 can be provided to create a channel for housing a wire of the heater 134, 234. The groove 370 may be substantially circular in shape, though other shapes such as triangular, square, rectangular, oval, or elliptical may also be used. When the floor of the groove forms a portion of a circle, the diameter D of the groove 370 or radius of curvature of the segment may be selected based upon the diameter of the wire used in the heater. As a result, the wire may be intended to fit closely within the groove 370. The groove 370 may allow the wire to be effectively partially embedded in the rigid monolith 360 for increased contact surface area between the wire and the liquid transport element 336, thereby increasing the amount of heat from the heater that is useful for vaporizing aerosol precursor composition within the liquid transport element.

The groove 370 also helps to control placement of the wire of the heater 134, 234 as it is being wound on the liquid transport element 336 to produce accurate and reproducible results during the manufacturing and/or assembly processes.

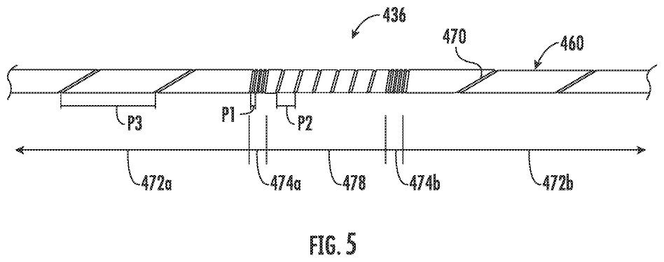

In FIG. 4, the helical groove 370 is illustrated with a consistent pitch P. The pitch P corresponds with the width along the longitudinal axis L of one complete turn (e.g. wind) of the groove 370 around the circumference of the rigid monolith 360. Another embodiment in FIG. 5 illustrates an exemplary embodiment of a liquid transport element 436 with a helical groove 470 with a variable pitch. Varying the pitch of the helical groove 470 will result in varying the concentration or amount of wire contacting or adjacent to various regions or portions of the liquid transport element 436, thus providing a technique for controlling the concentration of heat relative to portions of the liquid transport element 436 at various regions along the longitudinal axis L.

As shown in FIG. 5, the liquid transport element 436 may include a first end portion 472a and a second end portion 472b (collectively, “end portions 472”). Further, the liquid transport element 436 may comprise a first contact portion 474a and a second contact portion 474b (collectively, “contact portions 474”), and a heating portion 478. The contact portions 474 may be positioned between the end portions 472, and the heating portion 478 may be positioned between the contact portions.

The groove 470 may define a pitch that varies along the longitudinal length of the rigid monolith 460. The groove 470 within the contact portions 474 may define a first pitch P1, the groove within the heating portion 478 may define a second pitch P2, and the groove within the end portions 472 may define a third pitch P3.

Although not required, in some embodiments the third pitch P3 of the first end portion 472a may be substantially equal to the pitch of the second end portion 472b. Similarly, although not required, the first pitch P1 of the first contact portion 474a may be substantially equal to the pitch of the second contact portion 474b. Further, it should be noted that transitions between the end portions 472 and the contact portions 474, and between the contact portions and the heating portion 478 may result in the pitch of the groove 470 varying over the length of the individual portions. In this regard, the pitch of the groove 470 of a particular portion of the liquid transport element 436, as used herein, generally refers to an average pitch of the groove over the length of the referenced portion.

In some embodiments the first pitch P1 may be less than the third pitch P3, and the second pitch P2 may be less than the third pitch and greater than the first pitch. As described below, this configuration of the pitches P1, P2, P3 of the contact portions 474, heating portion 478, and end portions 472 may provide particular benefits in terms of the functionality and cost of an atomizer resulting from a heater wire disposed within the groove 470.

In one embodiment the first pitch P1 of the contact portions 474 may be substantially equal to a diameter of the groove 470. This pitch corresponds to a configuration in which the wraps of the groove are substantially directly adjacent to one another. As described below, this configuration may have certain advantages. However, various other embodiments of pitches of the groove may be employed in other embodiments.

In one embodiment, a ratio of the second pitch P2 to the first pitch P1 may be from about two though eight to one, and in one embodiment about four to one. The ratio of the third pitch P3 to the first pitch P1 may be from about eight through thirty-two to one, and in one embodiment about sixteen to one. The ratio of the third pitch P3 to the second pitch P2 may be from about one through sixteen to one, and in one embodiment about four to one.

By coupling a wire of a heater 134, 234 to the liquid transport element 436 in a manner by which the wire continuously extends along the longitudinal length of the liquid transport element and resides within the groove 470, the resulting atomizer may be produced continuously to the extent of the length of the material defining the wire and the liquid transport element.

In one embodiment, the contact portions 474 may comprise about three to about five wraps of the groove 470. Further, providing the contact portions 474 with a relatively small first pitch P1 may further facilitate establishing an electrical connection between the contact portions and the heater terminals.

The third pitch P3 of the end portions 472 may be relatively large to function as a pre-heater, without a primary intent of providing enough heat energy to the aerosol precursor within the end portions 472 of the liquid transport element 436 to cause vaporization. On the other hand, having the groove 470 extend outward from the connection portions 474 may improve the efficiency at which the liquid transport element 436 can be produced by providing a continuous groove 470 along the full length of the liquid transport element 436, and allowing for simultaneously manufacturing more than one liquid transport element, which can then be divided into suitable sections after the rigid monolith 460 is completed.

The heating portion 478 of the liquid transport element 436 is the region primarily tasked with vaporizing aerosol precursor. Therefore, producing the desired amount of heat in the heating portion 478 is important. The amount of heat available to the heating portion 478 can be controlled by adjusting the second pitch P2. In this regard, the second pitch P2 of the groove 470 in the heating portion 478 may be relatively less than the third pitch P3 in the end sections 472 but greater than the first pitch P1 of the groove in the contact portions 474. By ensuring that the winds of the groove 470 are not spaced too far apart within the heating portion 478, the liquid transport element 436 may be heated to a sufficient amount to produce aerosol vapors. Further, by providing gaps between the windings in the heating portion 478, the vaporized aerosol may be able to escape from the liquid transport element 436. The number of windings within the heating portion 478 may comprise from about four to about nine in some embodiments.

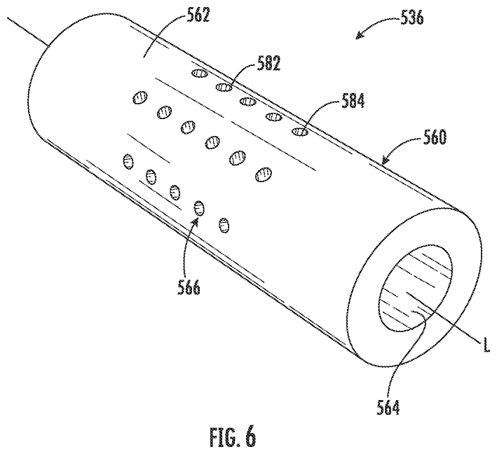

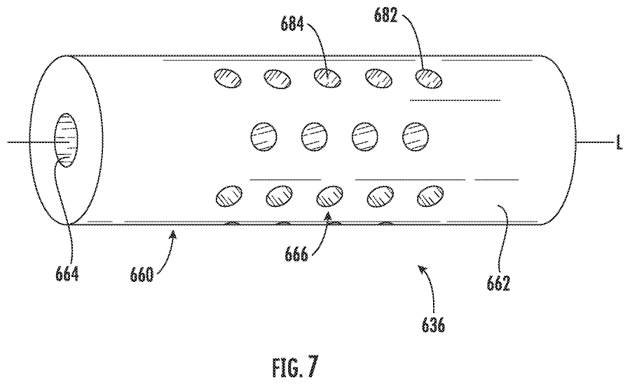

FIGS. 6 and 7 show similar liquid transport elements 536, 636 according to additional embodiments of the present disclosure. The liquid transport elements 536, 636 may provide increased vaporization efficiency by controlling the flow rate of aerosol precursor. Each liquid transport element 536, 636 may comprise a rigid monolith 560, 660 such as a porous monolith formed from porous glass or porous ceramic as discussed above. At least some of the rigid monolith 560, 660 may be configured substantially as a cylinder with a longitudinal axis L. The rigid monolith 560, 660 can include an exterior surface 562, 662. The rigid monolith 560, 660 may include one or more lumen 564, 664 extending substantially parallel with the longitudinal axis L. The one or more lumen 564, 664 may render the rigid monolith 560, 660 substantially hollow.

In one embodiment, as shown in FIGS. 1 and 3, a heater 134, 234 is configured to be at least partially wrapped around the exterior surface 562, 662 of the rigid monolith 560, 660. Returning to FIGS. 6 and 7, the exterior surface 562, 662 is formed or otherwise processed to include at least one surface discontinuity 566, 666.

In the illustrated embodiments of FIGS. 6 and 7, the surface discontinuity 566, 666 comprises at least one opening 582, 682 to at least one bore 584, 684. The bores 584, 684 extend radially relative to the longitudinal axis L. The bores 584, 684 may extend fully across the diameter of the monolith 560, 660. Alternatively, the bores 584, 684 may extend from the exterior surface 562, 662 into communication with one or more lumen, if present, extending along the longitudinal axis L. Further still, the bores 584, 684 may be blind holes that extend from the exterior surface 562, 662 only partially into the monolith 560, 660 to result in a closed, radially inner end. In other embodiments, particularly where additive manufacturing is used, the bores 584, 684 may extend radially outwardly relative to the longitudinal axis from the lumen 564, 664 toward, but not reaching the exterior surface 562, 662. The axis of the bores 584, 684 is not limited to the radial direction but may form an angle with the longitudinal axis of about 30 degrees to about 90 degrees.

The bores 584, 684 may each have the same diameter or the diameters of the bores may vary. The diameter of the bores may range from about 50 microns to about 2000 microns or from about 150 microns to about 350 microns. In some embodiments, the size of the bores 584, 684 is influenced by the diameter of a wire used in the heating element. In the illustrated embodiments, a plurality of bores 584, 684 are arrayed along the longitudinal axis L and around the longitudinal axis. In one embodiment, the rows of the array extend along the longitudinal axis L and the bores 584, 684 in one row are staggered with respect to the bores in an adjacent row. In other embodiments the bores in each row are aligned. In one embodiment, the size and quantity of bores 584, 684 may be selected to create a ratio of bore opening area to exterior surface area of about 1% to about 25%. This range is selected for its rate of liquid release from the interior surface to the exterior surface of the rigid monolith. A goal is to balance aerosol generation as a function of the thermal energy made available from the heating element while seeking to reduce charring of aerosol precursor or incomplete aerosolization. In some embodiments, the quantity, size, or arrangement of the bores 584, 684 may be selected in conjunction with the pitch or number of wraps of the wire of the heating element.

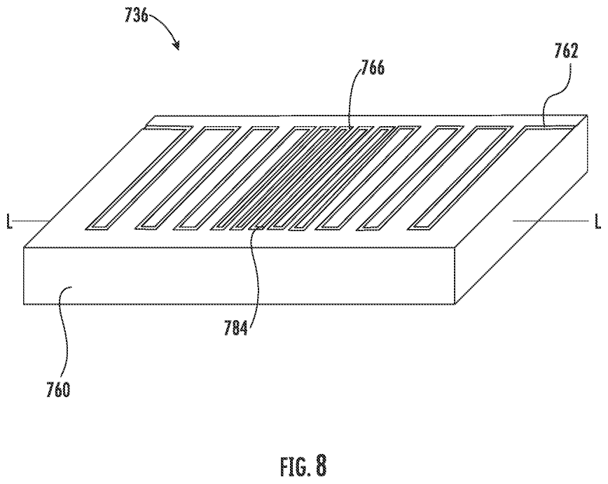

FIG. 8 shows a liquid transport element 736 according to an additional embodiment of the present disclosure. The liquid transport element 736 may comprise a rigid monolith 760 such as a porous monolith formed from porous glass or porous ceramic as discussed above. While the liquid transport element 736 has a longitudinal axis L (e.g. a major axis), the liquid transport element differs from the previously described embodiments because the liquid transport element is substantially flat, not cylindrical. The rigid monolith 760 can include an exterior surface 762, for example a substantially planar major face of a plate-shaped body. The rigid monolith 760 may include one or more lumen (not shown) extending substantially parallel with or perpendicular to the longitudinal axis L. The lumen may be generally parallel with the major face.

The exterior surface 762 of the rigid monolith 760 is formed or otherwise processed to include at least one surface discontinuity 766. The surface discontinuity 766 may be provided to engage with a heater 134, 234 (FIGS. 1 and 3) such as a heating wire that can be disposed within the surface discontinuity to increase heating efficiency of the liquid transport element 736. In the illustrated embodiment of FIG. 8, the surface discontinuity 766 comprises at least one continuous groove 784 cutting a path along the exterior surface 762. Each groove 782 may be continuous so that the heater, such as a heating wire, associated with the groove can still have both ends operatively and electrically connected to a power source. The pattern formed along the exterior surface 762 by the at least one continuous groove 784 can all be designed with the goal of controlling the quantity and distribution of heat transferred from a heater to the liquid transport element 736. For example, the pattern defined by the at least one continuous groove 784 may be a serpentine pattern. The density of the segments of the continuous groove 784, the surface coverage of the continuous groove on the exterior surface 762 and the spacing between adjacent segments can all be controlled. The continuous groove 784 can be designed based upon the discussion above with respect to the helical groove 470 (FIG. 5) with the pattern being variable at different portions of the exterior surface 762 of the monolith 760.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the appended claims. Although specific terms are employed herein, they are used in a generic and descriptive sense only and not for purposes of limitation.

1. A liquid transport element for an aerosol delivery device, the liquid transport element comprising:
a rigid monolith,
wherein the rigid monolith comprises an exterior surface and a longitudinal axis,
wherein the exterior surface comprises at least one discontinuity.

2. The liquid transport element of claim 1, wherein at least a portion of the rigid monolith is substantially cylindrical.

3. The liquid transport element of claim 2, wherein the at least one discontinuity is an opening to a bore.

4. The liquid transport element of claim 3, wherein the bore has a bore axis forming an angle with the longitudinal axis.

5. The liquid transport element of claim 3, wherein the bore extends radially relative to the longitudinal axis.

6. The liquid transport element of claim 5, wherein the bore comprises a plurality of bores arrayed along the longitudinal axis and around the longitudinal axis.

7. The liquid transport element of claim 6, wherein rows of the array extend along the longitudinal axis for at least a portion of a length of the cylinder.

8. The liquid transport element of claim 7, wherein the bores in one row are staggered with respect to the bores in an adjacent row.

9. The liquid transport element of claim 7, wherein the bores in one row are aligned with respect to the bores in an adjacent row.

10. The liquid transport element of claim 2, wherein the at least one discontinuity is a helical groove extending around and along the longitudinal axis for at least a portion of a length of the cylinder.

11. The liquid transport element of claim 10, wherein a pitch of the helical groove varies along the longitudinal axis.

12. The liquid transport element of claim 11, wherein the helical groove has a plurality of contact portions having a first pitch, and a heating portion positioned between the contact portions having a second pitch,
wherein the second pitch is greater than the first pitch.

13. The liquid transport element of claim 12, wherein the first pitch is substantially equal to a diameter of the wire.

14. The liquid transport element of claim 12, wherein the helical groove further comprises a plurality of end portions, the groove in the end portions having a third pitch,
wherein the first pitch is less than the third pitch, and the second pitch is less than the third pitch.

15. The liquid transport element of claim 2, wherein the cylindrical portion is hollow.

16. The liquid transport element of claim 2, wherein the rigid monolith is a porous ceramic or porous glass.

17. The liquid transport element of claim 1, wherein the exterior surface is substantially planar.

18. The liquid transport element of claim 17, wherein the at least one discontinuity is a continuous groove cutting a path along the exterior surface.

19. An atomizer comprising:
a fluid transport element, comprising:
a rigid monolith,
wherein the rigid monolith comprises an exterior surface and a longitudinal axis,
wherein the exterior surface comprises at least one discontinuity; and
a heater comprising a conductive heating element engaged with the discontinuity, the conductive heating element configured to generate heat through resistive heating or inductive heating.

20. The atomizer of claim 19, wherein the heating element is a wire.

21. The atomizer of claim 19, wherein at least a portion of the rigid monolith is substantially cylindrical.

22. The atomizer of claim 21, wherein the at least one discontinuity is an opening to a bore.

23. The atomizer of claim 22, wherein the bore extends radially relative to the longitudinal axis.

24. The atomizer of claim 22, wherein the bore extends at an angle relative to the longitudinal axis.

25. The atomizer of claim 22, wherein the bore comprises a plurality of bores arrayed along the longitudinal axis and around the longitudinal axis along at least a portion of the length of the cylinder.

26. The atomizer of claim 25, wherein rows of the array extend along the longitudinal axis and the bores in one row are staggered with respect to the bores in an adjacent row.

27. The atomizer of claim 25, wherein rows of the array extend along the longitudinal axis and the bores in one row are aligned with respect to the bores in an adjacent row.

28. The atomizer of claim 21, wherein the at least one discontinuity is a helical groove extending around and along the longitudinal axis for at least a portion of a length of the cylinder.

29. The atomizer of claim 28, wherein a pitch of the helical groove varies along the longitudinal axis,
wherein the helical groove has a plurality of contact portions having a first pitch, and a heating portion positioned between the contact portions having a second pitch,
wherein the second pitch is greater than the first pitch.

30. The atomizer of claim 29, wherein the helical groove further comprises a plurality of end portions defining a third pitch,
wherein the first pitch is less than the third pitch, and the second pitch is less than the third pitch.

31. The atomizer of claim 19, wherein the exterior surface is substantially planar, and
wherein the at least one discontinuity is a continuous groove cutting a path along the exterior surface.

31. An aerosol delivery device comprising:
an outer housing;
a reservoir containing a liquid;
a heater configured to vaporize the liquid; and
a liquid transport element configured to provide the liquid to the heater;
wherein the liquid transport element comprises:
a rigid monolith, at least a portion of the rigid monolith is substantially cylindrical,
wherein the cylindrical portion comprises an exterior surface and a longitudinal axis,
wherein the exterior surface comprises at least one discontinuity.
